(19) United States
(12) Patent Application Publication
(10) Pub. No.: US 2019/0263563 A1
(43) Pub. Date: Aug. 29, 2019

(54) BUCKET STACKING RING

(71) Applicant: Timothy Shane McClure, Desert Hot Springs, CA (US)

(72) Inventor: Timothy Shane McClure, Desert Hot Springs, CA (US)

(21) Appl. No.: 16/285,205

(22) Filed: Feb. 26, 2019

Related U.S. Application Data
(60) Provisional application No. 62/636,432, filed on Feb. 28, 2018.

(51) Int. Cl. B65D 21/02; B65G 57/00

(52) U.S. Cl. CPC B65D 21/0224; B65D 43/0218; B65G 57/005

(57) ABSTRACT

Disclosed is a stackable ring replacement (known as the bucket stacking ring) for commercially purchased buckets. The bucket stacking ring facilitates stacking of buckets in a stable and structured manner The bucket stacking ring may be designed for a circular bucket and is comprised of entirely plastic materials. Through an effective seal, the bucket (with the ring placed atop) has its contents contained with the assistance of a bucket stacking ring insert. Further, a bucket (which is concurrently stacked atop the bucket maintaining the bucket stacking ring) is approximately two inches down into the lower bucket. Thus, the upper bucket is locked into place and supported by the walls of the lower bucket. The interior walls of the upper portion of the lower bucket surround the outer bottom portion of the upper bucket which is lowered into the lower bucket through the facilitation of the stacking ring.

### CROSS-REFERENCE TO RELATED PATENT DOCUMENTS

This patent application claims the benefit of priority of U.S. Provisional Application No. 62/636,432, entitled “Bucket Stacking Ring,” filed Feb. 28, 2018, which are hereby incorporated herein by reference in its entirety.

### FIELD OF THE INVENTION

The present invention relates generally to container and lid assemblies, and, more particularly, to a bucket stacking ring for facilitating a secure connection between buckets when stacking a bucket atop another bucket. This stacking is accomplished by means of a ring replacement that is sealed or placed onto a top portion of a lower bucket that allows another bucket to be stacked atop the lower bucket and to be lowered into the lower bucket such that the another bucket is supported by interior walls of the aforementioned lower bucket.

### BACKGROUND

With the disorganization involved in the standard bucket storage systems, including buckets that may not be stacked in a stable or structured manner, the need for a device which allows the stabilization and organization of the buckets has become a necessity. With the commercial buckets and the standard lids included with the commercial buckets that are currently available in the market for purchases, the possibility of sliding off or being knocked over is quite common when they are placed atop one another.

The prior art discloses numerous types of lids that are configured for stacking the buckets atop one another. Such assemblies are shown in U.S. Pat. Nos. 3,967,731, 3,989,142, 4,111,329, 5,143,219, and 7,264,135. The U.S. Pat. No. 3,967,731 describes a stackable lid and container combination wherein the container has vertically and horizontally offset annular beveled rim portions for stacking engagement with like portions of similar containers. The U.S. Pat. No. 3,989,142 describes a stackable container lid for a bucket comprising a generally circular lid having center portion surrounded by a series of polyhedrons, one plane of which extends upwardly at right angles from the lid surface, thereby forming a perimeter into which the bottom of the bucket can be inserted. The U.S. Pat. No. 4,111,329 describes a tamperproof container and cap assembly in which the container carries a circumferential radially extending flange which cooperates with the skirt of the cap to prevent the cap from being removed until a portion of the cap skirt is removed. The U.S. Pat. No. 5,143,219 describes a stackable container including a continuous sidewall interconnecting a lip means and the bottom along with a lid for engaging the lip and for covering an open end of the stackable container. The U.S. Pat. No. 7,264,135 describes a stackable container lid including a lid member having a center portion, an edge portion, top and bottom surfaces and closure means, the closure means being disposed proximate the edge portion and adapted to cooperate with the closure device of the container, the lid top surface including an engagement member, the engagement member being disposed in the lid member center portion and projecting outwardly from the top surface, the lid bottom surface including a recessed bottom region adapted to receive the engagement member of another said lid.

Despite various improvements, compressive forces of long duration with such stacking can still cause distortion in the lid and bucket which provide sealing of the container. Furthermore, the structure of the lids are not readily adapted to placing or stacking of one upon the other for storage and/or dispensing from an automated lid-dispensing apparatus. Additionally, such lids commonly have a minimum sealing engagement with container lip portions. In light of the foregoing, there exists a need for an improved and reliable solution that solves the above-mentioned problems and presents an improved stacking member that is easy to use and offers stability during stacking of the buckets atop each other.

### BRIEF SUMMARY

It is an objective of the present invention to provide a bucket stacking ring for facilitating a secure connection between buckets when stacking a bucket atop another bucket. Such stacking may be accomplished by means of a ring that is sealed or placed onto a top portion of a first bucket (i.e., a lower bucket) that allows a second bucket to be stacked atop the first bucket. Further, the second bucket may be lowered into the first bucket such that the second bucket is supported by interior walls of the first bucket and/or the ring.

With the use of the ring disclosed in the present invention, high stability and safety during stacking of the buckets may be achieved. Thus, the ring of the present invention may replace the lids atop a bucket. The bucket stacking ring of the present invention functions as follows: by replacing the standard lid of a first bucket with the bucket stacking ring, the bucket stacking ring allows or facilitates a second bucket to be stacked atop the first bucket (i.e., the lower bucket) and the second bucket sits lower into the opening of the first bucket. The bucket stacking ring allows or facilitates the second bucket (which sits atop the first bucket) to be supported by the walls or boundaries of the first bucket by means of the bucket stacking ring by permitting the second bucket (i.e., the upper bucket) to be lowered into the first bucket. The second bucket may be lowered up to a designated distance into the first bucket which may vary according to bucket dimensions and/or ring dimensions. In an exemplary embodiment, the second bucket may be locked into place within the first bucket.

In an exemplary embodiment of the present invention, the bucket stacking ring has been designed for use with a standard five gallon buckets which may be purchased at hardware and craft stores, and anything which may fit within such buckets may be safely stored. In an embodiment, the bucket stacking ring may allow or facilitate a secure connection between the second bucket that is stacked atop the first bucket, and may be as effective as the originally provided lid. The second bucket (which sits atop the first bucket) is not secured by the lidded system in the same manner as the first bucket, but the distance up to which the second bucket is lowered into the first bucket through the facilitation of the bucket stacking ring may allow for its securement. in an embodiment, the bucket stacking ring and the bucket stacking ring insert may be comprised of plastic, but may also have rubber portions incorporated for a more effective seal when storing perishable items. In an embodiment, the bucket stacking ring and the bucket stacking ring insert may be produced in a variation of colors, or may be manufactured in a transparent color allowing for a consumer to view the contents of a bucket without removing the lid insert. The bucket stacking ring insert (i.e., a lid or dust cover) may be optional and can be used based on preference of the consumer. If the consumer wishes to use the bucket stacking ring insert, then the consumer may place the bucket stacking ring insert over the bucket stacking ring, thereby covering the bucket stacking ring and hence the bucket, and thus the content inside the bucket is not visible. However, if the consumer does not wish to use the bucket stacking ring insert, then the consumer may not place the bucket stacking ring insert over the bucket stacking ring, and thus the content inside the bucket may be visible through opening of the bucket stacking ring.

In the present invention, at least two variations of the bucket stacking ring have been contemplated. In one embodiment, a solid shelf design with an opening and an open shelf design with a lid have been contemplated. The solid shelf design may act as a typical lid having a flat solid surface covering the entire surface area of the bucket opening. The open shelf design may include an opening along a sub-section of the interior top surface area of the bucket (such as the first or second bucket) that allows or facilitates the consumer to be able to see, remove, or add content from/to the bucket without having to remove the bucket stacking ring. In another embodiment, the open shelf design may include a base interior lip for maintaining a secondary lid insert to be placed on top of the open shelf design. This may create a securely covered lid, thus allowing attachment or detachment of the cover lid insert without removing the ring from the bucket.

In an embodiment, the bucket stacking ring may be comprised of plastic or rubber materials and its dimensions are developed in accordance with the dimensions of the buckets or containers for which the consumer wishes to stack. The bucket stacking ring may be re -designed to be configurable and suitable to stack hardware containers, building supplies containers, food storage containers, hobby and craft containers, camping containers, gardening containers, pet food storage containers, construction containers, and many other applications known in the art. Moreover, the bucket stacking ring is not limited to being circular, but rather can be adapted to be oval, square, triangle, or any other shape suitable for the applicable containers that are intended for stacking without departing from the scope of the disclosed invention. Also, the size of the bucket stacking ring disclosed herein is amendable and the bucket stacking ring may be designed and manufactured having differing sizes and shapes and still capturing the novelty of the present invention.

In the preferred embodiment of the present invention, the bucket stacking ring may include an outer lip which encapsulates the outer rim of the bucket. The outer lip of the bucket stacking ring may sit near flush with the outer rim of the bucket, and may maintain approximately four-degree angling and span along the circumference of the bucket's outer rim. Attached to the top rim of the bucket is the lip connection which sits atop the full circumference of the rim of the bucket, thereby facilitating the hanging of the outer lip as well as attaching the outer lip to the inner lip. The inner lip may be similar to the outer lip such that it hangs into the interior of the bucket and spans vertically into the interior of the bucket, covering the circumference of the inner lip of the bucket.

Also included in the preferred embodiment of the present invention is a base internal lip which extends from the bottom portion of the interior lip. The base internal lip may extend inward from the interior lip at a ninety-degree angle and may provide a shelf-structure on which the second bucket (stacked atop the first bucket) may rest comfortably into the first bucket.

When the bucket stacking ring is installed within a bucket rim, it allows for the base internal lip to sit approximately two (2) inches below the top of the bucket rim, thereby allowing the second bucket stacked atop of the bucket stacking ring (typically measuring 14 inches) to sit about 2 inches within the top portion of the first bucket.

In an embodiment of the present invention, the bucket stacking ring may sit atop of the bucket rim and provide stacking capabilities or functionalities for stacking other buckets on top of the first bucket. Moreover, in an alternate embodiment, the bucket stacking ring may be locked into a place along the top of the bucket rim of the first bucket for providing stacking capabilities or functionalities for stacking other buckets on top of the first bucket.

In a preferred embodiment of the present invention, the bucket stacking ring may rest directly along an open rim of a container or bucket, acting as a replacement for a lid of the container or bucket. In an alternate embodiment, the bucket stacking ring may rest directly on top of an existing lid, wherein the existing lid is fixed on top of an open top sided container or bucket.

These and other features and advantages of the present invention will become apparent from the detailed description below, in light of the accompanying drawings.

### BRIEF DESCRIPTION OF THE ACCOMPANYING DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of various examples. It is expressly understood, however, that the drawings are for the purpose of illustration and description only and are not intended as a definition of the limits of the invention. Embodiments of this invention will now be described by way of example in association with the accompanying drawings in which:

FIGS. 1A and 1B show a top perspective view of a bucket stacking ring, in accordance with an embodiment of the present invention;

FIG. 2 shows radial and line diagrams of the bucket stacking ring including its ratios, proportions, and placements of its parts, in accordance with an embodiment of the present invention;

FIG. 3 shows a top perspective view of the bucket stacking ring fitted atop a bucket in accordance with an embodiment of the present invention;

FIG. 4 shows a top perspective view of a placement of buckets atop each other using bucket stacking rings, in accordance with an embodiment of the present invention; and

FIG. 5 shows a bucket stacking ring insert, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes a bucket stacking ring. Accordingly, the components have been represented, showing only specific details that are pertinent for understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

Techniques consistent with the present invention provide, among other features, a bucket stacking ring for facilitating a secure connection between buckets when stacking a bucket atop another bucket. Unless stated otherwise, terms such as “first” and “second” are used to arbitrarily distinguish between the elements or entities. Thus, these terms are not necessarily intended to indicate temporal or other prioritization of such elements or priorities. While various exemplary embodiments of the disclosed systems and methods have been described above, it should be understood that they have been presented for purposes of example only, and not limitations. It is not exhaustive and does not limit the invention to the precise form disclosed. Modifications and variations are possible in light of the above teachings or may be acquired from practicing of the invention, without departing from the breadth or scope.

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The bucket stacking ring will now be described with reference to the accompanying drawings, which should be regarded as merely illustrative without restricting the scope and ambit of the present invention.

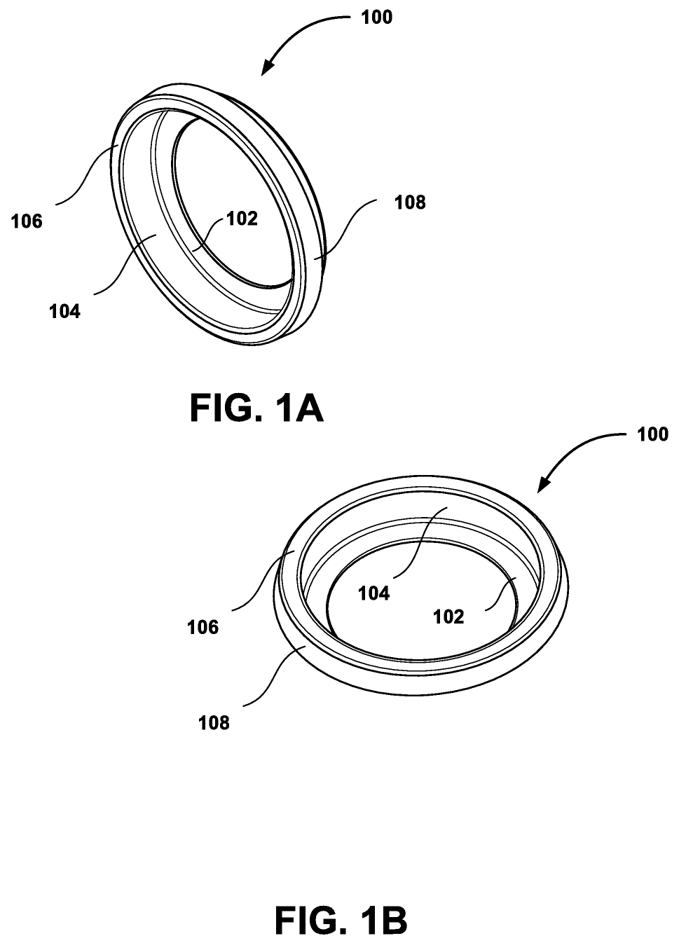

FIGS. 1A and 1B show a top perspective view of a bucket stacking ring 100, in accordance with an embodiment of the present invention. FIGS. 1A and 1B are an illustration of the bucket stacking ring 100 in a preferred embodiment of the present invention. It is a three-dimensional (3D) depiction of the bucket stacking ring 100 that has been oriented to reveal the preferred embodiment of the present invention as it appears in a physical state.

In FIGS. 1A and 1B, the bucket stacking ring 100 has been shown and the bucket stacking ring 100 includes a base internal lip 102, an inner lip 104, a lip connection 106, and an outer lip 108.

In an embodiment, the base internal lip 102 is situated in an inwardly-extended position through the circumference (or along the circumference) of the interior of the bucket stacking ring 100 as shown in the preferred embodiment of the present invention in FIGS. 1A and 1B. The base internal lip 102 may extend at a ninety (90) degree angle from the base of the inner lip 104.

In an embodiment, the inner lip 104 (as illustrated in FIGS. 1A and 1B) may surround the circumference of the interior of a bucket over which the bucket stacking ring 100 may be placed for stacking atop another bucket. The inner lip 104 has been illustrated such that the inner lip 104 may extend vertically into the interior of the bucket for a specific distance or depth before facilitating the inwards, horizontal orientation of the base internal lip 102.

In an embodiment, the lip connection 106 (as illustrated in FIGS. 1A and 1B) may connect to the inner lip 104 and the outer lip 108. The lip connection 106 may sit at a level and at a horizontal angle across the top lip of the bucket, spanning around or over the circumference of the bucket lip of the bucket. The lip connection 106 may be referred to as the lip connector 106 without limiting the scope of the present invention.

In an embodiment, the outer lip 108 (as illustrated in FIGS. 1A and 1B) may extend vertically down along the outside of the bucket for a specific distance or depth at a predefined angle such as a four (4) degree angle. The outer lip 108 is molded to the lip connection 106. Therefore, the outer lip 108 may be able to rest against the entirety of the outer circumference of the bucket.

In an embodiment, the base internal lip 102, the inner lip 104, the lip connection 106, and the outer lip 108 of the bucket stacking ring 100 may be comprised of plastic or rubber materials. Further, the dimensions of the bucket stacking ring 100 may be developed in accordance with the dimensions of the buckets or containers for which a consumer wishes to stack. The bucket stacking ring 100 may be re-designed to be configurable and suitable to stack hardware containers, building supplies containers, food storage containers, hobby and craft containers, camping containers, gardening containers, pet food storage containers, construction containers, and many other applications known in the art.

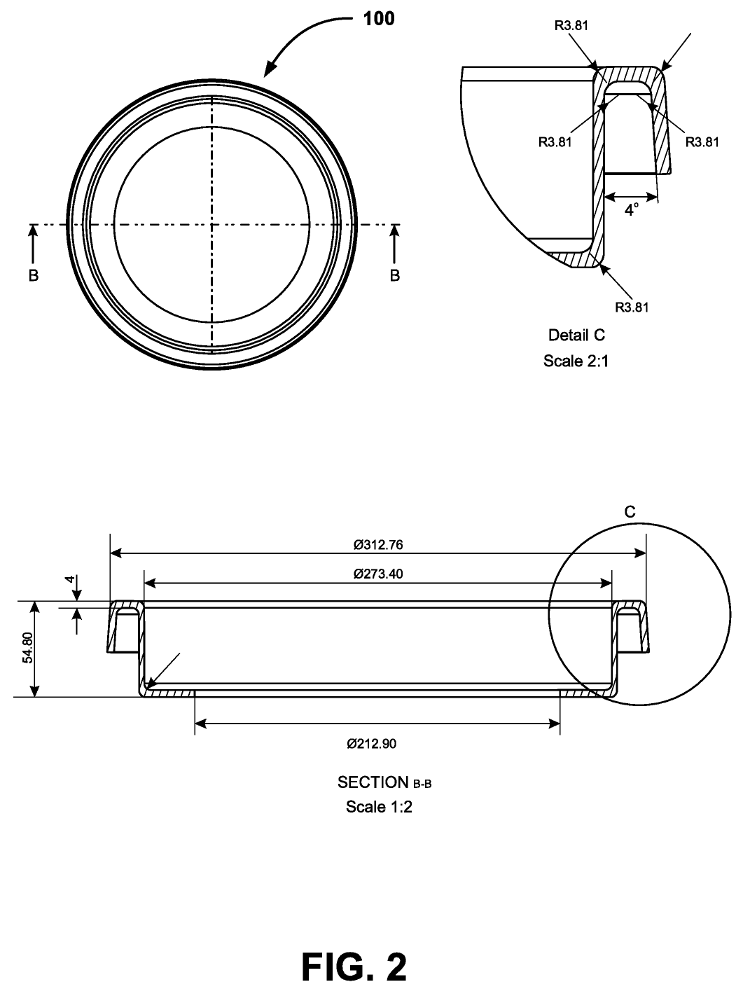

FIG. 2 shows radial and line diagrams of the bucket stacking ring 100 including its ratios, proportions, and placements of its parts, in accordance with an embodiment of the present invention. In the preferred embodiment of the present invention, relationship between all portions of the bucket stacking ring 100, including the inner lip 104 and the outer lip 108 portions as they connect to the base internal lip 102 and the lip connection 106 has been shown in FIG. 2.

Furthermore, in FIG. 2, an enhanced view of the relationship between the inner lip 104 and the outer lip 108 as it relates to the lip connection 106 has been illustrated and described as “Detail C”. Detail C is a scale of 2:1 in relation to the illustration shown at the bottom of FIG. 2. Also accompanying this illustration in FIG. 2 is a bird's eye view (for example, a top view) of the bucket stacking ring 100 in order to present or illustrate the symmetrical and perfectly circular dimensions of the bucket stacking ring 100 in the preferred embodiment of the present invention.

The bird's eye view (as illustrated in FIG. 2) functions to exemplify the symmetrical nature of the bucket stacking ring 100 in the preferred embodiment of the present invention. Organized vertically through the diameter of the bucket stacking ring 100 is a line dividing the bucket stacking ring 100 in half in an illustrative format. Also illustrated is a horizontal line that is organized through the diameter of the bucket stacking ring 100 such that the horizontal line divides the bucket stacking ring 100 in half as well. This allows for a quartering of the bucket stacking ring 100, and thereby illustrating the circular and proportional dimension of the bucket stacking ring 100 as a perfectly circular, 360-degree dimension.

To the furthest right of the illustrations shown in FIG. 2, there is further shown an enhanced illustration of the inner lip 104 and the outer lip 108, as well as the lip connection 106, known as “Detail C”. Within Detail C, the lip connection 106 is the uppermost portion of the bucket stacking ring 100 of the preferred embodiment of the present invention, which is organized over the lip of the bucket with which the bucket stacking ring 100 is attached to or placed over. The lip connection 106 is organized in a horizontal manner such that the lip connection 106 rests against the flat portion of the top of the rim of the bucket i.e., effectively sitting or overlapping across the entirety of the circumference of the flat, upper lip portion of the bucket.

Further illustrated in Detail C of FIG. 2 is the outer lip 108. The outer lip 108 may be oriented at approximately four (4) degree angle away from the outer wall of the bucket. The outer lip 108 is placed vertically down the outside of the bucket at an approximately four (4) degree angle, and its length is approximately half in comparison to the length of the inner lip 104. The dimensions of the outer lip 108 may vary according to the bucket size of the bucket under consideration.

Also included in Detail C of FIG. 2 is the relationship of the inner lip 104 with the lip connection 106. The inner lip 104 sits at a ninety (90) degree angle in relation to the lip connection 106. The inner lip 104 extends downward into the bucket at a vertical orientation, and rests flush to the interior bucket wall of the bucket, spanning along the full circumference of the interior lip of the bucket wall. The inner lip 104 extends around the circumference of the interior bucket lip such that the inner lip 104 is extending down. For example, the inner lip 104 may be extending down approximately two (2) inches when designed for a standard five gallon bucket. This distance may vary based on dimensions of other buckets.

In FIG. 2, there is further illustrated a full side view of the bucket stacking ring 100 of the preferred embodiment of the present invention. In relation to Detail C, this illustration is of a 1:2 ratio. The illustration of FIG. 2 depicts the preferred embodiment of the present invention from a sectional view, and hence allowing for a view of the internal structure of the bucket stacking ring 100 as though it was divided in half. The dashed lines illustrated within FIG. 2 function to reveal the solid plastic portions of the bucket stacking ring 100. The solid lines, organized horizontally and connecting the lip connectors on the left and right sides of the drawing, function to show the level structure of the bucket stacking ring 100 and its symmetrical structure.

In FIG. 2, there is further illustration of the base internal lip 102 that extends out at a ninety (90) degree angle from the bottom of the inner lip 104. The base internal lip 102 is organized along the circumference (e.g., inner circumference) of the bucket, and extends level and horizontally towards the center of the bucket. Its extension is approximately one (1) inch when the bucket stacking ring 100 is designed for the standard five gallon bucket, but may vary when designed for the buckets of other dimensions. The base internal lip 102 in FIG. 2 is connected with lines that are horizontal, solid lines connecting the left and right sides of the base internal lip 102. This horizontal, solid lines may function to show the level nature of the base internal lip 102.

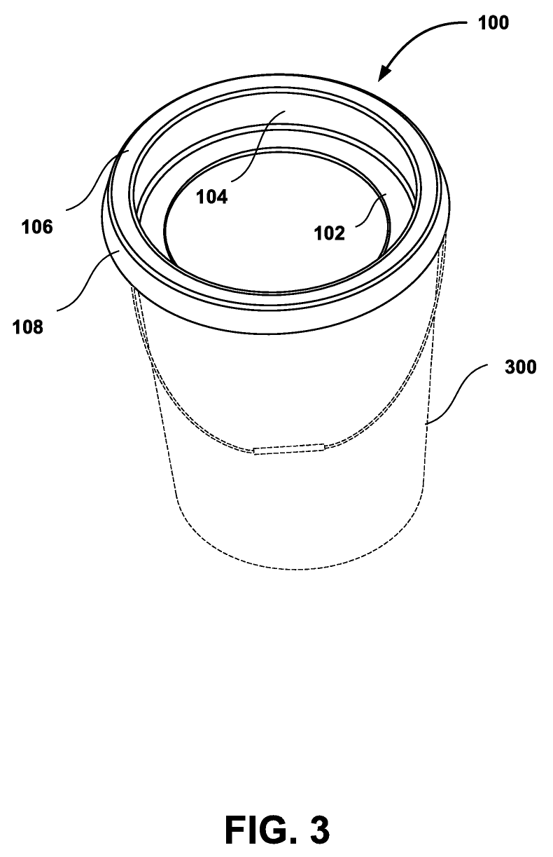

FIG. 3 shows a top perspective view of the bucket stacking ring 100 fitted atop a bucket 300, in accordance with an embodiment of the present invention. In an exemplary embodiment of the present invention, the bucket stacking ring 100 has been placed atop a five-gallon bucket such as the bucket 300. Similar to FIG. 1, FIG. 3 illustrates the relationship between the inner lip 104 and the outer lip 108 to the lip connection 106. It has been shown in FIG. 3 that the outer lip 108 extends vertically down and around the circumference of the outside of the bucket 300 up to a specific distance or depth. Further, the inner lip 104 extends down the interior of the bucket 300 for a specific distance or depth, spanning around the circumference of the interior of the bucket 300. Further, the base internal lip 102 extends out from the base of the inner lip 104 for a specific distance. This base internal lip 102 is a shelving unit over which the upper bucket may be stacked atop the bucket 300.

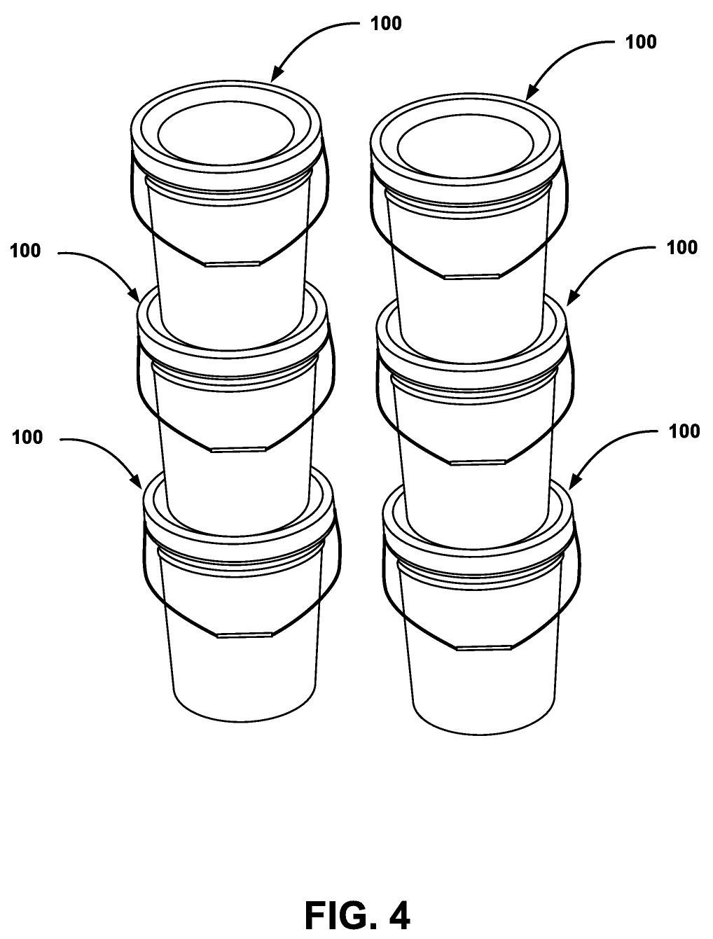

FIG. 4 shows a top perspective view of a placement of buckets atop each other using the bucket stacking rings 100, in accordance with an embodiment of the present invention. FIG. 4 shows the sue of the bucket stacking rings 100 when implemented on five gallon buckets. For example, a bottom bucket is shown with the bucket stacking ring 100 between itself and a middle bucket such that the middle bucket is placed or stacked atop the bucket stacking ring 100 of the bottom bucket. Further, the middle bucket is shown with the bucket stacking ring 100 between the middle bucket and a top bucket such that the top bucket is placed or stacked atop the bucket stacking ring 100 of the middle bucket.

The portions of the bucket stacking ring 100 (as shown in FIG. 4) is the outer lip 108 which is organized vertically down the circumference of the outside of each bucket's outside lip. In FIG. 4, all buckets depicted are of the same dimensions. Further, from FIG. 4, it can be seen that the middle bucket is resting into the bottom bucket at a specific distance or depth through the facilitation of the bucket stacking ring 100 of the present invention. It can also be seen that the top bucket is resting into the middle bucket at a specific distance or depth through the facilitation of the bucket stacking ring 100 of the present invention.

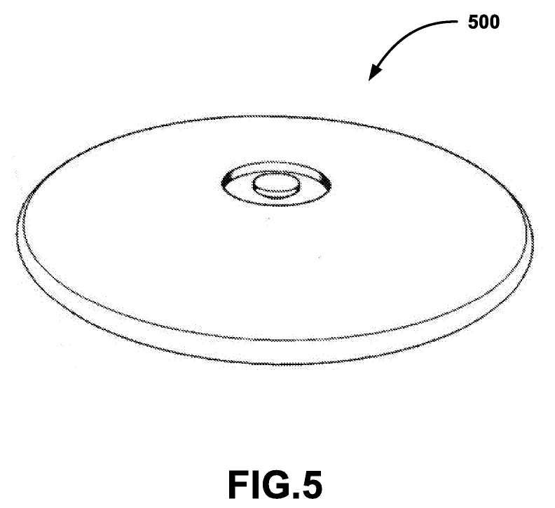

FIG. 5 shows a bucket stacking ring insert 500, in accordance with an embodiment of the present invention. The bucket stacking ring insert 500 may be configured to reside within the inside perimeter of the bucket stacking ring 100. The bucket stacking ring insert 500 is removeable. Further, the bucket stacking ring insert 500 may have solid edge for facilitating perfect fit atop or squeezed alongside the base interior lip 102. The bucket stacking ring insert 500 (i.e., a lid or dust cover) may be optional and can be used when warranted by the consumer. If the consumer wishes to use the bucket stacking ring insert 500, then the consumer may place the bucket stacking ring insert 500 over the bucket stacking ring 100. If the consumer does not wish to use the bucket stacking ring insert 500, then the consumer may leave aside the bucket stacking ring insert 500, and the bucket stacking ring 100 may be used without the bucket stacking ring insert 500. In one scenario, if the bucket stacking ring 100 (placed on a bottom bucket) is open (i.e., the bucket stacking ring insert 500 has not been placed over the bucket stacking ring 100) and there is a top bucket placed over the bucket stacking ring 100, then the consumer can take the top bucket off the bucket stacking ring 100, and the consumer can see what is inside the bottom bucket without removing the bucket stacking ring 100. In another scenario, if the bucket stacking ring 100 (placed on a bottom bucket) is open (i.e., the bucket stacking ring insert 500 has not been placed over the bucket stacking ring 100) and there is no top bucket placed over the bucket stacking ring 100, then the consumer can see what is inside the bottom bucket without removing the bucket stacking ring 100. Thus, the use of the bucket stacking ring insert 500 is up to the discretion of the consumer and can be removed to view what is inside the bucket without removal of the bucket stacking ring 100.

Although particular embodiments of the invention have been described in detail for purposes of illustration, various modifications and enhancements may be made without departing from the spirit and scope of the invention.

What is claimed is:

1. A bucket stacking ring for a bucket, comprising:
a base internal lip;
an inner lip;
a lip connection; and
an outer lip,
wherein the base internal lip extends at a ninety degree angle from a base of the inner lip,
wherein the inner lip extends vertically into interior of the bucket for a specific distance before facilitating inwards, horizontal orientation of the base internal lip,
wherein the lip connection connects to the inner lip and the outer lip, and
wherein the outer lip molds to the lip connection to rest against entirety of an outer circumference of the bucket.

2. The bucket stacking ring of claim 1, wherein the base internal lip is situated in an inwardly-extended position through circumference of an interior of the bucket stacking ring.

3. The bucket stacking ring of claim 2, wherein the inner lip surrounds the circumference of the interior of the bucket over which the bucket stacking ring is placed for stacking atop another bucket.

4. The bucket stacking ring of claim 3, wherein the lip connection sits at a level and at a horizontal angle across a top lip of the bucket such that the lip connection is spanning around the circumference of the top lip of the bucket.

5. The bucket stacking ring of claim 4, wherein the outer lip extends vertically down along an outside of the bucket for a specific distance at a predefined angle.

6. The bucket stacking ring of claim 5, wherein the predefined angle corresponds to a four degree angle.

7. The bucket stacking ring of claim 6, wherein the outer lip is oriented at the four degree angle away from an outer wall of the bucket.

8. The bucket stacking ring of claim 1, wherein the base internal lip, the inner lip, the lip connection, and the outer lip are comprised of plastic or rubber materials.

9. The bucket stacking ring of claim 1, wherein a length of the outer lip is half of a length of the inner lip.

10. The bucket stacking ring of claim 1, wherein the base internal lip is organized along an inner circumference of the bucket, and extends level and horizontally towards center of the bucket.

11. The bucket stacking ring of claim 1, further comprising a bucket stacking ring insert for residing within an inside perimeter of the bucket stacking ring.

12. The bucket stacking ring of claim 11, wherein the bucket stacking ring insert is removeable and includes solid edge for facilitating perfect fit atop or squeezed alongside the base interior lip.
